(19) United States
(12) Patent Application Publication
(10) Pub. No.: US 2024/0402309 A1
(43) Pub. Date: Dec. 5, 2024

(54) Light Detection and Ranging Apparatus and Event Detection Method Thereof

(71) Applicant: Compertum Microsystems Inc., Hsinchu City (TW)

(72) Inventor: Francis Piu MAN, Hsinchu City (TW)

(73) Assignee: Compertum Microsystems Inc., Hsinchu City (TW)

(21) Appl. No.: 18/203,660

(22) Filed: May 31, 2023

(51) Int. Cl. G01S 7/4863; G01S 7/481; G01S 7/486; G01S 7/4865; G01S 17/10; G01S 17/89

(52) U.S. Cl. CPC G01S 7/4863; G01S 7/4817; G01S 7/4865; G01S 7/4868; G01S 17/10; G01S 17/89

(57) ABSTRACT

A LiDAR apparatus includes a light transmitter configured to emit pulse light, a light receiver configured to capture reflected pulse light, a determination circuit configured to determine a plurality of distances to the at least one object and a plurality of reflectivity of the at least one object, and an event detector configured to output the present distance or the present reflectivity only after determining a distance difference between the present distance of the first pixel of the present frame and a previous distance of the first pixel of a previous frame exceeds a distance threshold or only after determining a reflectivity difference between the present reflectivity of the first pixel of the present frame and a previous reflectivity of the first pixel of the previous frame exceeds a reflectivity threshold. A plurality of pixels are regularly mapping to a two-directional FOV of the LiDAR apparatus.

### BACKGROUND OF THE INVENTION

### 1. Field of the Invention

The present invention relates generally to a LiDAR for surveying the surrounding environment, and more particularly, to a LiDAR for tracking, positioning, and motion estimation in the surrounding environment.

### 2. Description of the Prior Art

A LIDAR emits non-visible laser signals to objects within the FOV and measuring the time delay between emitted and returned laser signals to calculate distances. Every time interval, a conventional LiDAR, also known as a frame-based LiDAR, would send out point cloud data in a frame.

For machine vision tasks, such as object recognition, which require abundant amount of data, a conventional frame-based LiDAR is well suited. However, for tasks, such as tracking, positioning, and motion estimation, which call for quick responses, a frame-based LiDAR which produces a large amount of redundant data is not desirable. Therefore, there is a need for a new type of LiDAR that assures fast response.

### SUMMARY OF THE INVENTION

An embodiment of the present disclosure provides a LiDAR apparatus comprising a light transmitter, configured to emit pulse light, wherein the pulse light is non-visible; a light receiver, optically coupled to the light transmitter and configured to capture reflected pulse light, wherein the reflected pulse light represents the pulse light reflected by at least one object; a determination circuit, coupled to the light transmitter and the light receiver, wherein the determination circuit is configured to determine a plurality of distances to the at least one object and a plurality of reflectivity of the at least one object; and an event detector, coupled to the determination circuit, wherein the event detector is configured to obtain a present distance of a first pixel of a present frame and a present reflectivity of the first pixel of the present frame, the event detector is configured to output the present distance or the present reflectivity only after determining a distance difference between the present distance of the first pixel of the present frame and a previous distance of the first pixel of a previous frame exceeds a distance threshold or only after determining a reflectivity difference between the present reflectivity of the first pixel of the present frame and a previous reflectivity of the first pixel of the previous frame exceeds a reflectivity threshold, the plurality of distances comprises the present distance, the plurality of reflectivity comprises the present reflectivity, and a plurality of pixels comprising the first pixel are regularly mapping to a two-directional field of view (FOV) of the LiDAR apparatus.

An embodiment of the present disclosure provides an event detection method, for a LiDAR apparatus, comprising obtaining a present distance of a first pixel of a present frame or a present reflectivity of the first pixel of the present frame; and output the present distance or the present reflectivity only after determining a distance difference between the present distance of the first pixel of the present frame and a previous distance of the first pixel of a previous frame exceeds a distance threshold or only after determining a reflectivity difference between the present reflectivity of the first pixel of the present frame and a previous reflectivity of the first pixel of the previous frame exceeds a reflectivity threshold; wherein a plurality of pixels comprising the first pixel are regularly mapping to a two-directional field of view (FOV) of the LiDAR apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams of LiDAR apparatuses according to embodiments of the present invention.

FIG. 3 is a schematic diagram of the mapping of point cloud data within the two-directional FOV and the corresponding data structure of a LiDAR apparatus according to an embodiment of the present invention.

FIG. 4 is a flowchart of an event detection method according to an embodiment of the present invention.

FIG. 5 and FIG. 6 are schematic diagrams of LiDAR apparatuses according to embodiments of the present invention.

FIG. 7 is a schematic diagram of the mapping of point cloud data within the two-directional FOV and the corresponding data structure of a LiDAR apparatus according to an embodiment of the present invention.

FIG. 8 is a flowchart of an event detection method according to an embodiment of the present invention.

FIG. 9 is a schematic diagram of a LiDAR apparatus according to an embodiment of the present invention.

FIG. 10 is a schematic diagram of the mapping of point cloud data within the two-directional FOV and the corresponding data structure of a LiDAR apparatus according to an embodiment of the present invention.

### DETAILED DESCRIPTION

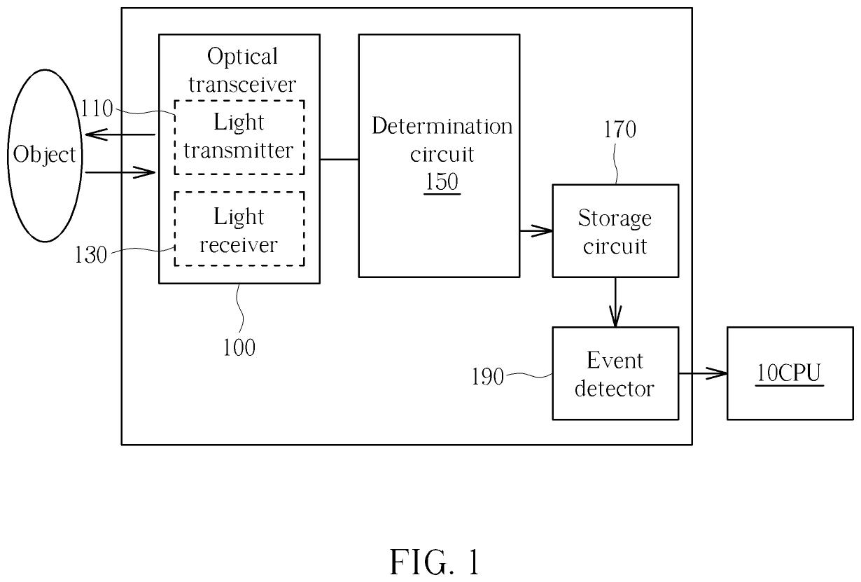

FIG. 1 is a schematic diagram of a LiDAR apparatus 10, which includes an optical transceiver 100, a determination circuit 150, a storage circuit 170, and an event detector 190.

The optical transceiver 100 may include a light transmitter 110 and a light receiver 130. The light transmitter 110 may include light source(s), each of which is configured to emit pulse light (e.g., non-visible pulse light). The light receiver 130 is configured to capture the reflected pulse light. In an embodiment, the light receiver 130 is a Geiger mode avalanched photodiode receiver, which may include the light detector(s) configured to measure the intensity of the reflected pulse light and convert it to a photo-current (i.e., an electrical-current signal) that is dependent on (e.g., proportional to) the light intensity. In an embodiment, the optical transceiver 100 may further include a beam steering unit.

The determination circuit 150 is configured to find distance(s) between object(s) and the LiDAR apparatus 10 and reflectivity of the object(s). The determination circuit 150 may detect the emission timing of the pulse light emitted from the light transmitter 110 and the receipt timing of the pulse light emitted from the light transmitter 110 to determine the distance(s) between the object(s) and the LiDAR apparatus 10. The determination circuit 150 may detect the intensity of the reflected pulse light to determine the reflectivity of the object(s), given that the intensity of the pulse light is preset/premeasured by the determination circuit 150. Here, reflectivity is related to the ratio of the intensity of the reflected pulse light to the intensity of the pulse light.

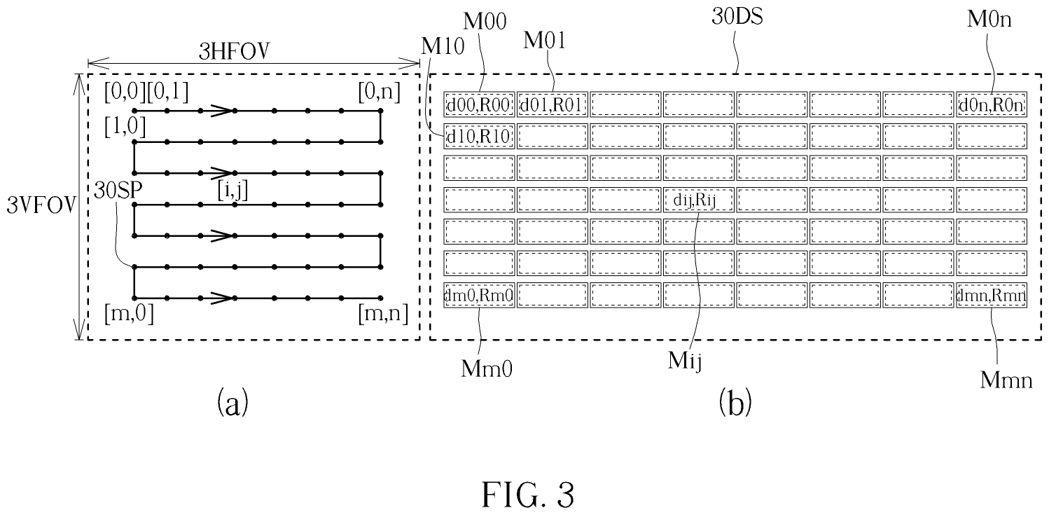

The storage circuit 170 (e.g., a memory device) may include memory unit(s) (e.g., memory units M00 to Mmn shown in (b) of FIG. 3) configured to store/record the distance(s) (e.g., distances d00 to dmn shown in (b) of FIG. 3) or the reflectivity (e.g., reflectivity R00 to Rmn shown in (b) of FIG. 3) for all pixels (e.g., pixels [0,0]-[m,n] shown in (a) of FIG. 3) over the entire two-directional FOV in each frame (or time interval). In terms of a pixel [m,n], the distance dmn of the frame t1 may be denoted as dₜ₁mn, and the reflectivity Rmn of the frame t1 may be denoted as Rₜ₁mn.

The event detector 190 (e.g., a digital transmitter) is configured to output the distance(s) (e.g., dₜ₁ij) or reflectivity (e.g., Rₜ₁ij) of certain pixel(s) (e.g., [i,j]) in a certain frame (e.g., t1) to the processing circuit 10CPU asynchronously if the difference (e.g., |dₜ₁ij−dₜ₀ij|) between the distance of the pixel of the (present) frame and another distance (e.g., dₜ₀ij) of the pixel of a (last/previous) frame (e.g., t0) exceeds a distance threshold dth or if the difference (e.g., |Rₜ₁ij−Rₜ₀ij|) between the reflectivity of the pixel of the (present) frame and reflectivity (e.g., Rₜ₀ij) of the pixel of the (last/previous) frame exceeds a reflectivity threshold Rth.

In an embodiment, a processing circuit 10CPU (e.g., a central processing unit) may be disposed externally to the LiDAR apparatus 10. Alternatively, the LiDAR apparatus 10 may further include the processing circuit 10CPU.

In short, the LiDAR apparatus 10, which acts as an event-based LiDAR apparatus, is able to efficiently extract meaningful point cloud data of certain pixel(s) in frame(s) from all the point cloud data of all the pixels in all the frames detected by the LiDAR apparatus 10. By analyzing the meaningful point cloud data, the processing circuit 10CPU is able to quickly detect/identify anomalous object(s) or event(s) that may have occurred, providing valuable insights for further analysis.

In an embodiment, after the light receiver 130 receives the reflected pulse light from pixel(s) [i, j] of the frame t1, the event detector 190, for each pixel, compares the difference |dₜ₁ij−dₜ₀ij| between the distances dij of the frame and its previous frame. For each pixel, if the difference is greater than the distance threshold dth, an event indicating an anomalous distance is flagged and the event detector 190 immediately outputs the distance dₜ₁ij and its corresponding reflectivity Rₜ₁ij to the processing circuit 10CPU externally. If the event indicating an anomalous distance is not flagged, the event detector 190, for each pixel, compares the difference |Rₜ₁ij−Rₜ₀ij| between the reflectivity Rij of the frame and its previous frame. For each pixel, if the difference is greater than the distance threshold Rth, an event indicating anomalous reflectivity is flagged and the event detector 190 immediately outputs the reflectivity Rₜ₁ij and its corresponding distance dₜ₁ij to the processing circuit 10CPU externally. If the event indicating an anomalous reflectivity is not flagged, the event detector 190 may start to check the next pixel or the next frame.

In another embodiment, the event detector 190, for each pixel, may first compare the difference |Rₜ₁ij−Rₜ₀ij| between the reflectivity Rij of the frame and its previous frame, and then compare the difference |dₜ₁ij−dij| between the distances dij of the frame and its previous frame.

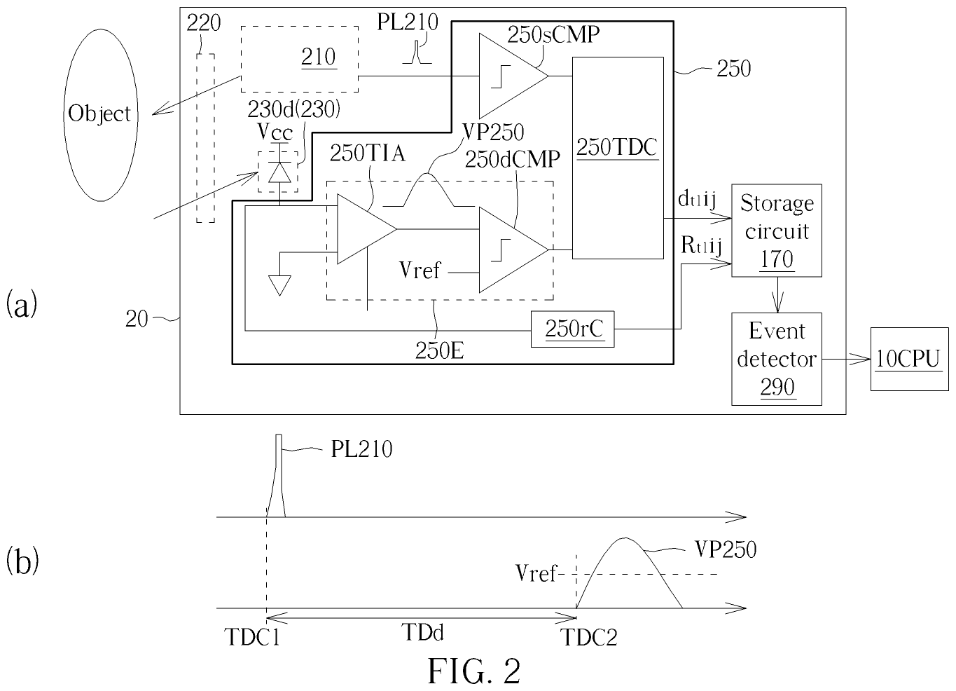

FIG. 2 is a schematic diagram of a LiDAR apparatus 20, which includes a light transmitter 210, a beam steering unit 220, the light receiver 230, a determination circuit 250, the storage circuit 170, and an event detector 290. The determination circuit 250 may include an extraction circuit 250E, a comparator 250sCMP, converters 250TDC, and 250rC. The extraction circuit 250E may include an amplifier 250TIA and a comparator 250dCMP.

The light transmitter 210 may include one or more light sources; the light receiver 230 may include one or more light detectors 230d.

The beam steering unit 220 optically coupled between the light transmitter 210 and the light receiver 230 is configured to direct/steer the pulse light emitted from the light transmitter 210 and its reflected pulse light to be received by the light receiver 230. This allows the light transmitter 210 to be scanned in two-directional FOV. In an embodiment, the pulse light incident on the beam steering unit and reflected pulse light deflected by the beam steering unit are parallel or coaxial. Alternatively, the pulse light deflected by the beam steering unit and the reflected pulse light incident on the beam steering unit are parallel or coaxial.

The amplifier 250TIA (e.g., a trans-impedance amplifier) may be configured to measure the amplitude of the photo-current generated by the light detector 230d coupled to the amplifier 250TIA and convert the photo-current to a photo-voltage VP250 that is dependent on the detected light intensity. For instance, when the light detector 230d receives a light pulse, it may generate a current pulse that matches the light pulse's intensity. The amplifier 250TIA, in turn, produces the voltage pulse VP250 that corresponds to the received current pulse. The amplifier 250TIA may also function as an electronic filter (specifically, a low-pass filter) that removes/reduces high-frequency electrical noise. The amplifier 250TIA may include one or more voltage-amplification stages to increase the amplitude of the voltage pulse VP250 beyond that of the directly converted voltage pulse from the received current pulse.

The comparator 250dCMP coupled between the amplifier 250TIA and the converter 250TDC is configured to compare the photo-voltage VP250 with a reference voltage Vref. For example, when the photo-voltage VP250 rises above (or falls below) the reference voltage Vref, the comparator 250dCMP may produce a signal (e.g., an edge detection signal or a digital high level signal) to indicate the rising edge (or the falling-edge) of the photo-voltage VP250 based on its comparison.

The comparator 250sCMP coupled between the light transmitter 210 and the converter 250TDC is configured to detect changes in the intensity of the pulse light. It may output a signal (e.g., an edge detection signal or a digital high level signal) when it detects the rising edge (or the falling-edge) of a signal PL210 corresponding to the pulse light from the light transmitter 210 (i.e., seeing the rising edge of the pulse light).

The converter 250TDC (e.g., a time-to-digital converter) is configured to measure the time difference TDd between the time instant TDC2 of the rising edge of the photo-voltage VP250 and the time instant TDC1 of the rising edge of the signal PL210. The time instant TDC1 may correspond to the timing of the emission of the pulse light from the light transmitter 210, while the time instant TDC2 may correspond to the timing of the receipt of the reflected pulse light by the light receiver 230. For example, (b) of FIG. 2 is a timing diagram illustrating the chronological sequence of the time instants TDC1 and TDC2. The converter 250TDC may convert the time difference TDd into a value corresponding to the distance dij between an object and the LiDAR apparatus 20.

The converter 250rC (e.g., a current-to-reflectivity converter) is configured to transform the amplitude of the photo-current generated from the light detector 230d, the amplitude of the signal PL210 corresponding to the intensity of the pulse light, or a received signal strength indication (RSSI) into reflectivity Rij that is correlated with the light intensity detected by the light detector 230d.

The storage circuit 170, which is coupled between the converters 250TDC, 250rC, and the event detector 290, is configured to store/record distance(s) or reflectivity provided by the converters 250TDC and 250rC.

The event detector 290 is configured to calculate the differences between the distances/reflectivity of all the pixels of the frame and the distances/reflectivity of all the pixels of the previous frame almost one by one: For a frame, the event detector 290 may determine whether the difference for the distance/reflectivity of one pixel exceeds the distance/reflectivity threshold, and then determine whether the difference for the distance/reflectivity of another pixel exceeds the distance/reflectivity threshold.

In FIG. 3, (a) illustrates a two-directional scanning pattern 30SP across a horizontal field of view 3HFOV and a vertical field of view 3VFOV for the pulse light sent from the light transmitter 210 through the beam steering unit 220 of a LiDAR apparatus (e.g., 20 or 50). The LiDAR apparatus may be programmed to scan the pulse light along the two-directional scanning pattern 30SP, which may include a series of pixels [0,0]-[m,n]. Each of the pixels [0,0]-[m,n] is associated with a specific position/point within the entire FOV that the LiDAR apparatus is measuring (i.e., one-to-one mapping), and reflection may occur at object(s) located within a three-directional space that corresponds to the pixels [0,0]-[m,n]. One single cycle/frame of the two-directional scanning pattern 30SP may include (m+1)×(n+1) pixels. The two-directional scanning pattern 30SP may be modified to fit different system configuration.

A data structure 30DS shown in (b) of FIG. 3 may include a collection of data elements DS00 to DSmn. Each data element DSij corresponds to one pixel [i,j] and may include point cloud data such as one distance dij or reflectivity Rij associated with the pixel [i,j]. In an embodiment, the data elements DS00 to DSmn may occupy a contiguous area (e.g., the memory units M00 to Mmn) within the storage circuit 170. Alternatively, the physical addresses of the data elements DS00 to DSmn may be sparsely scattered.

For example, as the LiDAR apparatus scans, the beam steering unit may direct pulse light towards the pixels [0,0]-[m,n] along the two-directional scanning pattern 30SP. At each pixel [i,j], the pulse light is transmitted, reflected back once it hits an object, and then captured by the light receiver 230. The distance dij to the object and the reflectivity Rij of the object are measured and stored in respective memory unit Mij.

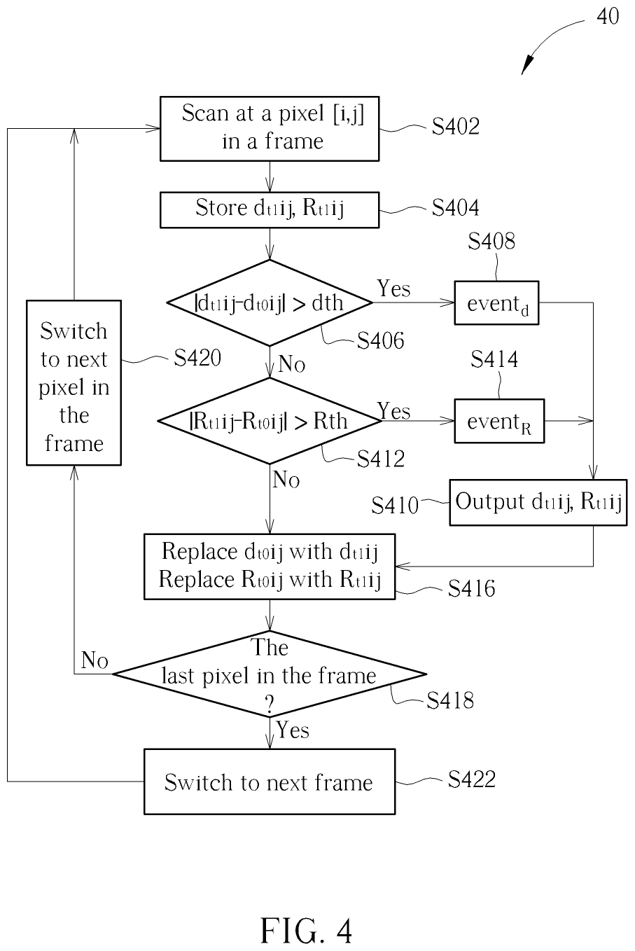

For example, FIG. 4 is a flowchart of an event detection method 40, also referred to as an event generation method. The event detection method 40, which may be compiled into a code and executed by the event detector of a LiDAR apparatus (e.g., 10, 20, or 50), may include the following steps:

Step S402: The LiDAR apparatus may scan at a pixel [i,j] in a frame t1.

Step S404: The distance dₜ₁ij and reflectivity Rₜ₁ij of the pixel [i,j] of the frame t1 may be stored in the storage circuit 170 of the LiDAR apparatus or a storage circuit of the event detector (e.g., a cache or a register of the event detector). The distance dₜ₁ij and reflectivity Rₜ₁ij may be read/accessed by the event detector.

Step S406: The event detector may compare the difference |dₜ₁ij−dₜ₀ij| between the distance dₜ₁ij of the present frame t1 and the distance dₜ₁ij of the previous frame t0 with the distance threshold dth. If the difference |dₜ₁ij−dₜ₁ij| exceeds the distance threshold dth, go to Step S408; otherwise, go to Step S412.

Step S408: The event detector may flag an event event_{d}.

Step S410: The event detector may immediately output the distance dₜ₁ij and the reflectivity Rₜ₁ij of the pixel [i,j] (to the processing circuit 10CPU).

Step S412: The event detector may compare the difference |Rₜ₁ij−Rₜ₀ij| between the reflectivity Rₜ₁ij of the present frame t1 and the reflectivity Rₜ₀ij of the previous frame t0 with the reflectivity threshold Rth. If the difference |Rₜ₁ij−Rₜ₀ij| exceeds the reflectivity threshold Rth, go to Step S414; otherwise, go to Step S416.

Step S414: The event detector may flag an event event_{R}.

Step S416: The event detector may replace the distance dₜ₀ij of the previous frame t0 with the distance dₜ₁ij of the present frame t1 and replace the reflectivity Rₜ₀ij of the previous frame t0 with the reflectivity Rₜ₁ij of the present frame t1.

Step S418: The event detector may determine whether the pixel [i,j] is the last pixel [m,n] of the frame t1. If no, go to Step S420; otherwise, go to Step S422.

Step S420: The event detector may move on to the next pixel (e.g., [i,j+1] or [i+1,j]) of the frame t1. In other words, the event detector may retrieve another distance (e.g., dₜ₁i(j+1) or dₜ₁(i+1)j) and reflectivity (e.g., Rₜ₁i(j+1) or Rₜ₁(i+1)j) of the next pixel of the frame t1 in Step S404, thereby enabling the event detector to process point cloud data for subsequent pixels.

Step S424: The event detector may move on to the next frame t2. In other words, the event detector may retrieve another distance dₜ₂00 and reflectivity Rₜ₂00 of a pixel [0,0] of the next frame t2 in Step S404, thereby enabling the event detector to process point cloud data for subsequent frames.

In an embodiment, steps S408 and S410 may be executed concurrently; steps S414 and S410 may be executed concurrently. In an embodiment, steps S406 (or S412) and S416 may be executed concurrently.

In an embodiment, the distance threshold dth or the reflectivity threshold Rth may be a preset constant value for all pixels or frames. Alternatively, the distance threshold dth or the reflectivity threshold Rth may vary over pixel or frame.

In an embodiment, a LiDAR apparatus has the ability to switch between normal mode and event mode. In the normal mode, the LiDAR apparatus, which may act as a frame-based LiDAR, may capture point cloud data within the entire FOV in one frame with a frequency f (e.g. 30 Hz). The point cloud data of all the pixels of the present frame (e.g., t0) may be sent out to the processing circuit 10CPU via the event detector at the present time stamp tt0, and the point cloud data of all the pixels of the next frame (e.g., t1) may be sent out at the following time stamp tt1, where tt1=tt0+1/f. The LiDAR apparatus may produce and output point cloud data only every time interval of 1/f. The event detector may essentially transmit point cloud data in parallel. This may result in redundant data transmission when there is no critical change(s) in the distance or reflectivity of a frame. For machine vision tasks which require abundant amount of data, the LiDAR apparatus in the normal mode is well suited.

In the event mode, the LiDAR apparatus, which may act as an event-based LiDAR apparatus, may perform the event detection method 40. As long as the LiDAR apparatus in the event mode identifies an event (e.g., event_{d} or event_{R}), the LiDAR apparatus immediately sends the corresponding point cloud data asynchronically/asynchronously to the processing circuit 10CPU without delay: In other words, not every pixel's point cloud data received by the event detector 290 is sent out; not every frame's point cloud data received by the event detector 290 is sent out. Any point cloud data that is not flagged with an event is not sent out to minimize redundant data transmission. For example, the event detector may output point cloud data of a first pixel (e.g., [0,1]) of a first frame (e.g., t1) at a first time stamp, point cloud data of the first pixel (e.g., [0,1]) of a second frame (e.g., t2) at a second time stamp, point cloud data of a second pixel (e.g., [m,1]) of a fourth frame (e.g., t4) at a fourth time stamp, and point cloud data of a third pixel (e.g., [8,5]) of a fifth frame (e.g., t5) at a fifth time stamp. All the point cloud data of a third frame (e.g., t3) may not output by the event detector to avoid unnecessary data transmission as there is no significant change between each pixel of the third frame and that of the second frame. The difference between the second time stamp and the first time stamp may be different from the difference between the fifth time stamp and the fourth time stamp or a time interval of 1/f. It enables the processing circuit to notice localized/sudden change(s) in distance or reflectivity and detect the presence of a (fast) oncoming car or a sudden stop by a car. Rather than waiting for a fixed time interval of 1/f to send out (potentially redundant) data, the LiDAR apparatus operated in the event mode may provide point cloud data at a rate faster than the frequency f. The LiDAR apparatus may be operated in the event mode to perform tasks like tracking, or positioning, and motion estimation which call for rapid response.

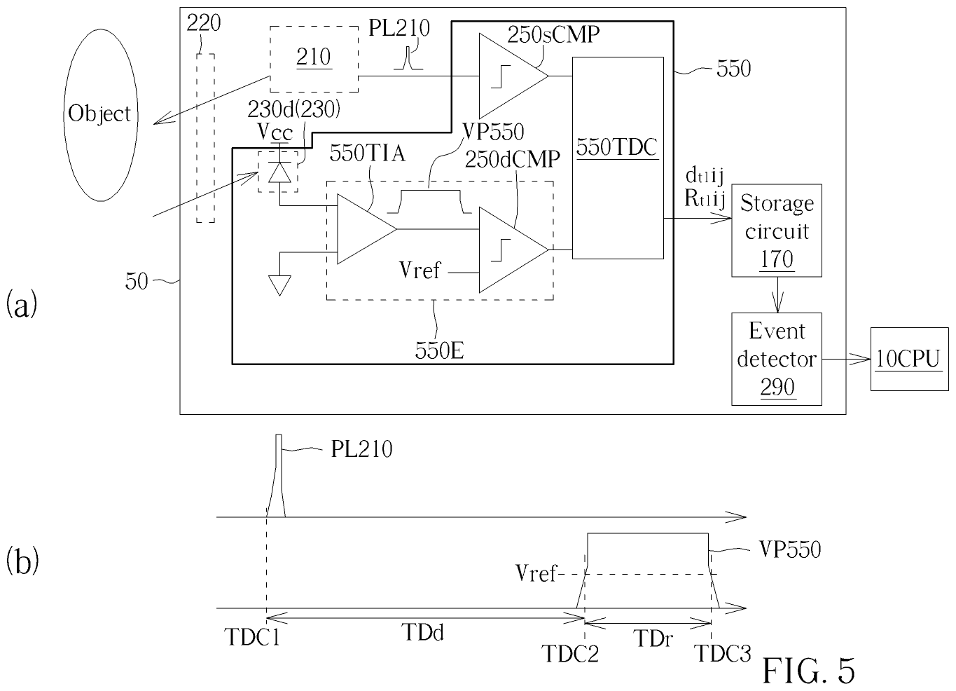

FIG. 5 is a schematic diagram of a LiDAR apparatus 50, which may be an event-based coaxial LiDAR apparatus as the LiDAR apparatus 20. Different from the LiDAR apparatus 20, a determination circuit 550 of the LiDAR apparatus 50 may include an extraction circuit 550E, the comparator 250sCMP, and a converter 550TDC. The extraction circuit 550E may include an amplifier 550TIA and the comparator 250dCMP. The converter 250rC is removed/absent from the LiDAR apparatus 50.

Different from the amplifier 250TIA, the amplifier 550TIA is a different type of trans-impedance amplifier, which has time duration dependent on the amplitude of the photo-current generated by the light detector 230d. Thus the amplitude of the photo-current may be measured by calculating the time difference TDr between a time instant TDC3 of the falling edge of a photo-voltage VP550 and the time instant TDC2 of the rising edge of the photo-voltage VP550.

Different from the converter 250TDC, the converter 550TDC may measure the time difference TDd between the time instant TDC2 and the time instant TDC1, and convert the time difference TDd into a value corresponding to the distance between an object and the LiDAR apparatus 50. The converter 550TDC may measure the time difference TDr between the time instant TDC3 and the time instant TDC2, and convert the time difference TDr into a value corresponding to reflectivity that is dependent on the light intensity detected by the light detector 230d. For example, (b) of FIG. 3 is a timing diagram illustrating the chronological sequence of the time instants TDC1, TDC2, and TDC3.

An event-based coaxial LiDAR apparatus (e.g., 20 or 50) allows early event detection. However, once an event is detected at a pixel (e.g., [0,0]) in a (present) frame (e.g., t1), the LiDAR apparatus will not trigger/initiate detection of another event at the same pixel until the next frame (e.g., t2), which is a time interval of 1/f after the present frame. Therefore, the temporal resolution is not improved. In an embodiment, multiple events may occur in vicinity in a frame, which demands a higher level of alertness. This increased level of alertness is crucial in discerning real events from false ones, which may arise due to surrounding noise. Event(s) (e.g., adjacent events) identified by the LiDAR apparatus may indicate area(s) of interest, and identifying event(s) only in certain area(s) of interest may increase temporal resolution. Besides, the main weakness of a coaxial LiDAR apparatus may be the use of few light detectors to cover a small FOV, which necessitates a beam steering unit to fully expand its FOV. However, since most beam steering units are mechanical-based, it takes a significant amount of time (e.g., 1/30 Hz) to scan the entire FOV.

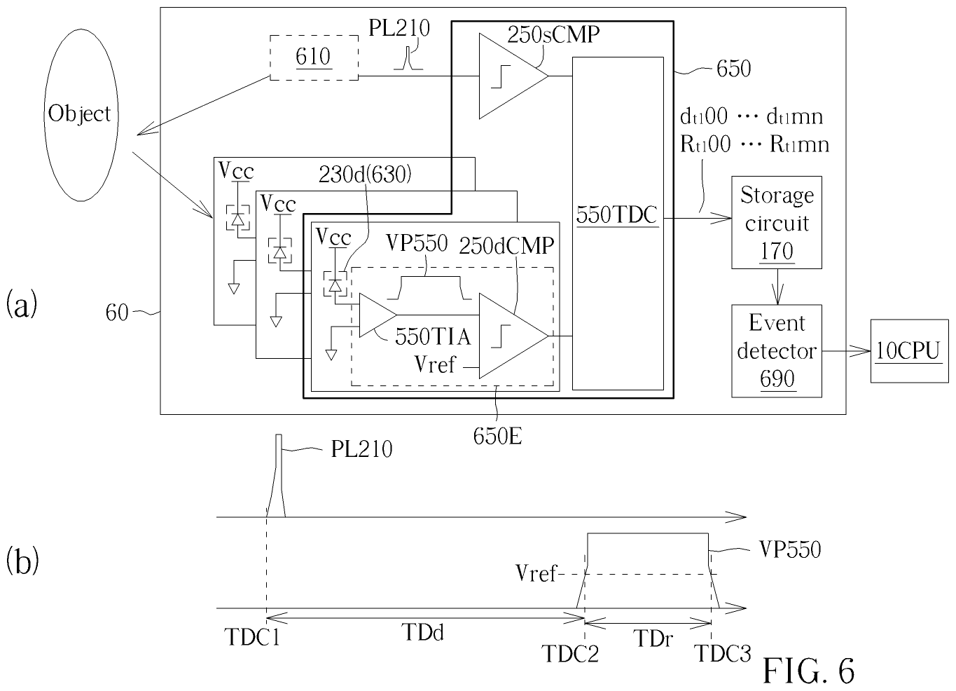

FIG. 6 is a schematic diagram of a LiDAR apparatus 60, which may improve temporal resolution. The LiDAR apparatus 60, which may be an event-based non-coaxial LiDAR apparatus, may include a light transmitter 610, a light receiver 630, a determination circuit 650, the storage circuit 170, and an event detector 690.

The light transmitter 610 may include light sources, each of which is configured to emit pulse light that flashes the entire FOV. The light receiver 630 may include the light detectors 230d to receive the reflected pulse light in two-directional FOV.

The determination circuit 650 may include extraction circuits 650E, the comparator 250sCMP, and the converter 550TDC. Each of the extraction circuits 650E may include the amplifier 550TIA and the comparator 250dCMP. The beam steering unit 220 and the converter 250rC are removed/absent from the LiDAR apparatus 60.

The event detector 690 is configured to calculate the differences between the distances/reflectivity of all the pixels of the frame and the distances/reflectivity of all the pixels of the previous frame almost simultaneously or at a time.

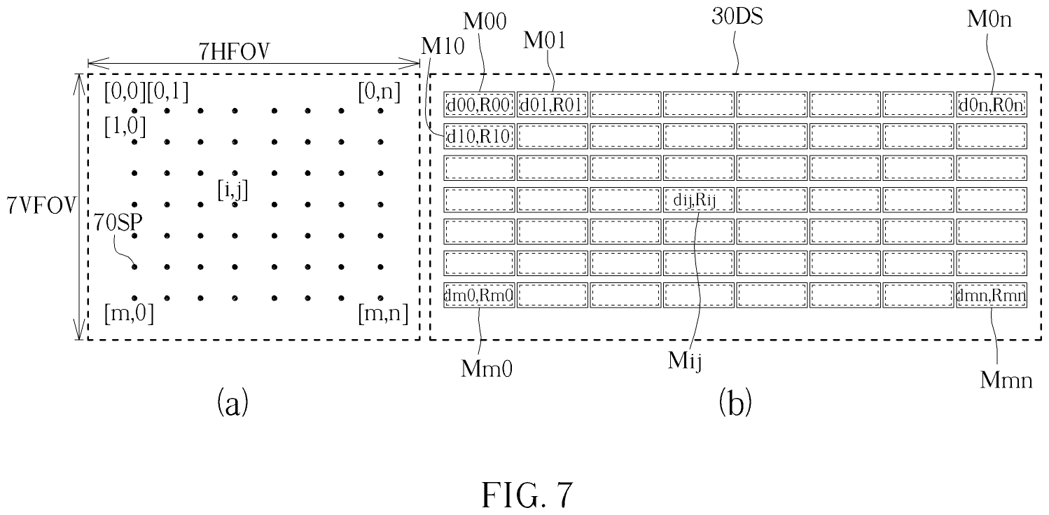

In FIG. 7, (a) illustrates a two-directional scanning pattern 70SP across a horizontal field of view 7HFOV and a vertical field of view 7VFOV for the pulse light sent from the light transmitter of a LiDAR apparatus (e.g., 60). The LiDAR apparatus may not be equipped with a beam steering unit (e.g., 220). In a flash, all the light sources of the light transmitter emit pulse light that covers the entire FOV. Once the pulse light hits object(s), it reflects off the object(s) and is then captured by an array of light detectors 230dthat also cover the entire FOV. One single cycle/frame of the two-directional scanning pattern 70SP may include (m+1)×(n+1) pixels, and the number of the extraction circuits 650E is equal to (m+1)×(n+1).

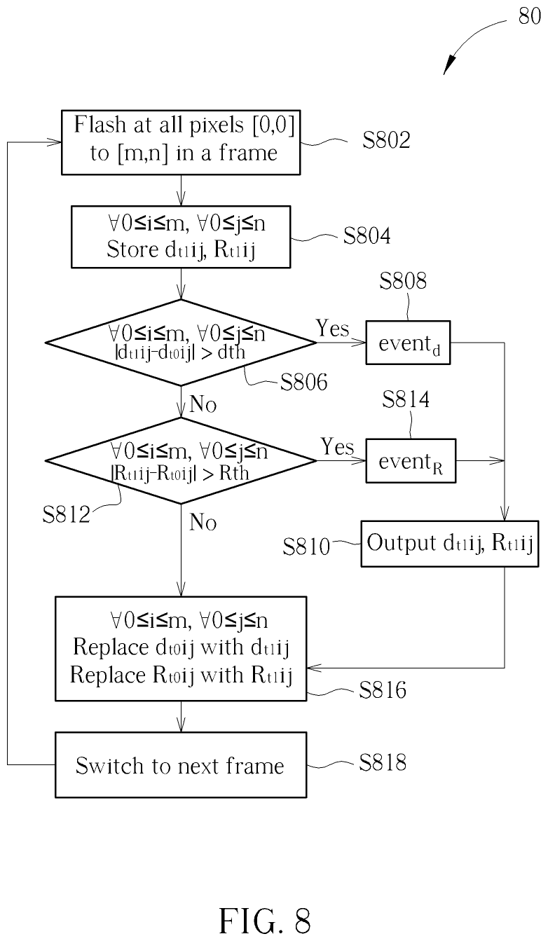

FIG. 8 is a flowchart of an event detection method 80 of a LiDAR apparatus (e.g., 10 or 60), which may include the following steps:

Step S802: The LiDAR apparatus may flash at all the pixels [0,0]-[m,n] in a frame t1.

Step S804: The distances dₜ₀00-dₜ₁mn and reflectivity Rₜ₁00-Rₜ₁mn of the pixels [0,0]-[m,n] of the frame t1 may be stored in the storage circuit 170 of the LiDAR apparatus or a cache/register of the event detector. The distances dₜ₁00-dₜ₁mn and reflectivity Rₜ₁00-Rₜ₁mn may be read/accessed by the event detector.

Step S806: For each pixel (e.g., [0,0], . . . or [m,n]), the event detector may compare the difference (e.g., |dₜ₁00−dₜ₀00|, . . . or |dₜ₁mn−dₜ₀mn|) between the distance (e.g., dₜ₁00, . . . or dₜ₁mn) of the present frame t1 and the distance (e.g., dₜ₀00, . . . or dₜ₀mn) of the previous frame t0 with the distance threshold dth. If any of the differences |dₜ₁00−dₜ₀00| to |dₜ₁mn−dₜ₀mn| exceeds the distance threshold dth, go to Step S808; otherwise, go to Step S812.

Step S808: The event detector may flag an event event_{d} for each difference (e.g., dₜ₁01, dₜ₁mn) greater than the distance threshold dth.

Step S810: The event detector may immediately output the distance(s) (e.g., dₜ₁01, dₜ₁mn) and the corresponding reflectivity (e.g., Rₜ₁01, Rₜ₁mn) of the pixel(s) (e.g., [0,1], [m,n]) corresponding to the event event_{d} or event_{R} (to the processing circuit 10CPU).

Step S812: For each pixel, the event detector may compare the difference (e.g., |Rₜ₁00−Rₜ₀00|, . . . or |Rₜ₁mn−Rₜ₀mn|) between the reflectivity (e.g., Rₜ₁00, . . . or Rₜ₁mn) of the present frame t1 and the reflectivity (e.g., Rₜ₀00, . . . or Rₜ₀mn) of the previous frame t0 with the reflectivity threshold Rth. If any of the differences |Rₜ₁00−Rₜ₀00| to |Rₜ₁mn−Rₜ₀mn| exceeds the reflectivity threshold Rth, go to Step S814; otherwise, go to Step S816.

Step S814: The event detector may flag an event event_{R} for each reflectivity (e.g., Rₜ₁mn) exceeding the reflectivity threshold Rth.

Step S816: For each pixel, the event detector may replace the distance (e.g., dₜ₀00, . . . or dₜ₀mn) of the previous frame t0 with the distance (e.g., dₜ₁00, . . . dₜ₁mn) of the present frame t1 and replace the reflectivity (e.g., Rₜ₀00, . . . or Rₜ₀mn) of the previous frame t0 with the reflectivity (e.g., Rₜ₁00, . . . or Rₜ₁mn) of the present frame t1.

Step S818: The event detector may move on to the next frame t2. In other words, the event detector may retrieve others distances dₜ₂00-dₜ₂mn and reflectivity Rₜ₂00-Rₜ₂mn of pixels [0,0]-[m,n] of the next frame t2 in Step S804, thereby enabling the event detector to process point cloud data for subsequent frames.

In an embodiment, steps S808 and S810 may be executed concurrently; steps S814 and S810 may be executed concurrently. In an embodiment, steps S806 (or S812) and S816 may be executed concurrently.

In terms of a non-coaxial LiDAR apparatus (e.g., 60), the frame rate, usually in the range of nanoseconds to microseconds, is defined by either the refresh rate of the light transmitter or the dead time of the light detectors 230d. The frame rate of a non-coaxial LiDAR apparatus is much faster than that of a coaxial LiDAR apparatus (e.g., 20). The frame rate of a coaxial LiDAR apparatus, typically on the order of milliseconds or tenths of a second, is determined by the time that the beam steering unit 220 scans through the whole FOV. Once an event detector of a coaxial LiDAR apparatus identifies an event (e.g., event_{d} or event_{R}), it immediately sends out the corresponding point cloud data of the event asynchronically to the processing circuit 10CPU without waiting for the next frame: The event detector may output point cloud data of pixels (e.g., [0,1], [3,5], [m,1]) of a first frame (e.g., t1) at a first time stamp, and point cloud data of pixels (e.g., [0,1], [10,2]) of a third frame (e.g., t3) at a third time stamp. A non-coaxial LiDAR apparatus offers high temporal resolution, making it advantageous for continuously tracking visual features.

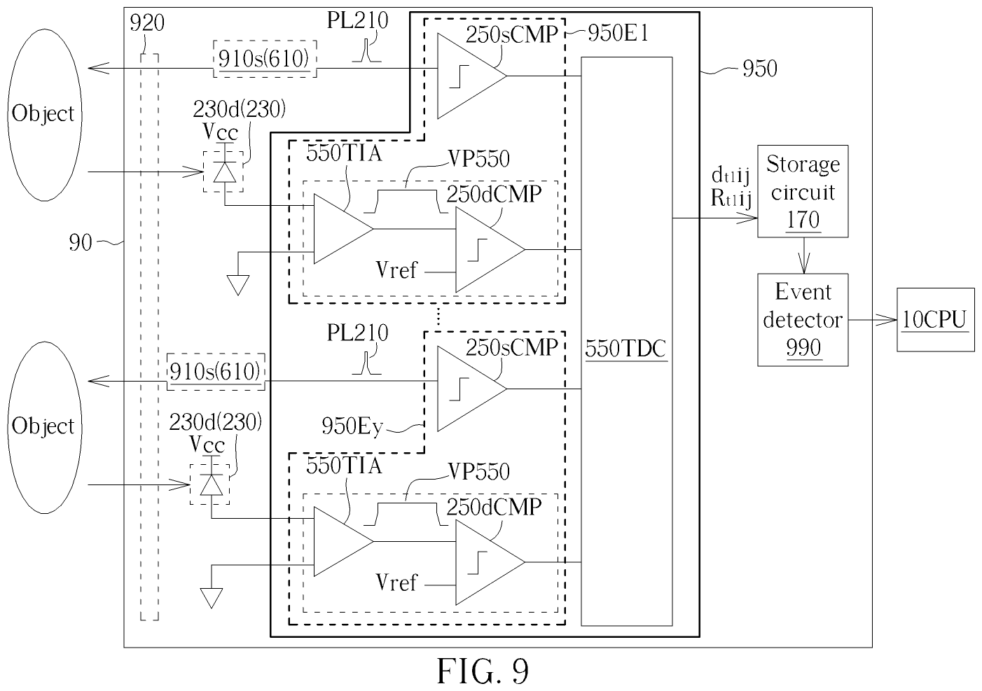

FIG. 9 is a schematic diagram of a LiDAR apparatus 90, which may be an event-based coaxial or non-coaxial LiDAR apparatus.

A determination circuit 950 may include extraction circuits 950E1 to 950Ey, and the converter 550TDC. Each of the extraction circuit 950E1 to 950Ex may include the comparator 250sCMP coupled to one light source 910s of the light transmitter 610, the amplifier 250TIA coupled to one light detector 230d, and the comparator 250dCMP.

A beam steering unit 920 optically coupled between the light transmitter 610 and the light receiver 630 is configured to direct/steer both the pulse light and its reflected pulse light. Alternatively, the beam steering unit 920 optically coupled to one of the light transmitter 610 and the light receiver 630 is configured to direct/steer one of the pulse light and its reflected pulse light. This allows the light transmitter 610 to be scanned in part of the two-directional FOV.

A event detector 990 is configured to calculate the differences between the distances/reflectivity of all the pixels of the frame and the distances/reflectivity of all the pixels of the previous frame almost group by group or row by row: For a frame, the event detector 990 may determine whether the differences for the distance/reflectivity of pixels of one group/row exceeds the distance/reflectivity threshold, and then determine whether the differences for the distance/reflectivity of pixels of another group/row exceeds the distance/reflectivity threshold.

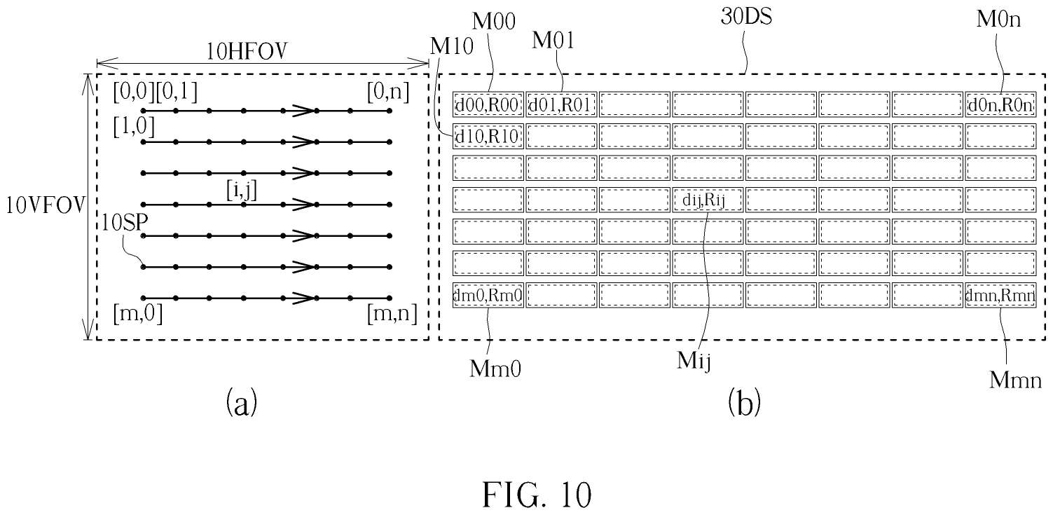

In FIG. 10, (a) illustrates a two-directional scanning pattern 10SP across a horizontal field of view 10HFOV and a vertical field of view 10VFOV for the pulse light sent from the light transmitter of a LiDAR apparatus (e.g., 90). In a flash, all the light sources of a light transmitter emit pulse light that covers part of the entire FOV. The LiDAR apparatus may be programmed to scan the pulse light along the two-directional scanning pattern 10SP, which may include a series of pixels (e.g., [0,0] to [0,n]). Once the pulse light hits object(s), it reflects off the object(s) and is then captured by the light detectors 230d that cover part of the entire FOV. One single cycle/frame of the two-directional scanning pattern 10SP may include (m+1)×(n+1) pixels, where y=(n+1).

The LiDAR apparatus 10 may be implemented using the LiDAR apparatus 20, 50, 60, or 90. Details or modifications of a beam steering unit, a light transmitter, a light source, a light receiver, or a light detector are disclosed in U.S. application Ser. Nos. 18/084,562 and 17/900,864,the disclosure of which is hereby incorporated by reference herein in its entirety and made a part of this specification. The determination circuit (e.g., 250), the storage circuit 170, the event detector (e.g., 290), the extraction circuit (e.g., 250E), or the processing circuit 10CPU may be implemented using combinations of software, firmware, or hardware. The variable i, j, m, n, x, or y may be any arbitrary positive integer.

To sum up, an event-based LiDAR apparatus is able to select meaningful point cloud data of certain pixel(s) in frame(s) from all the point cloud data obtained by the event-based LiDAR apparatus. As soon as the event-based LiDAR apparatus recognizes any meaningful point cloud data, the event-based LiDAR apparatus immediately sent the meaningful point cloud data out for timely detection and resolution. As a result, the processing circuit may be able to quickly identify potential anomalies by analyzing the meaningful point cloud data received from the event-based LiDAR apparatus and provide appropriate instruction or valuable data for further analysis. Besides, redundant data transmission is reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light detection and ranging (LiDAR) apparatus, comprising:
a light transmitter, configured to emit pulse light, wherein the pulse light is non-visible;
a light receiver, optically coupled to the light transmitter and configured to capture reflected pulse light, wherein the reflected pulse light represents the pulse light reflected by at least one object;
a determination circuit, coupled to the light transmitter and the light receiver, wherein the determination circuit is configured to determine a plurality of distances to the at least one object and a plurality of reflectivity of the at least one object; and
an event detector, coupled to the determination circuit, wherein the event detector is configured to obtain a present distance of a first pixel of a present frame and a present reflectivity of the first pixel of the present frame, the event detector is configured to output the present distance or the present reflectivity only after determining a distance difference between the present distance of the first pixel of the present frame and a previous distance of the first pixel of a previous frame exceeds a distance threshold or only after determining a reflectivity difference between the present reflectivity of the first pixel of the present frame and a previous reflectivity of the first pixel of the previous frame exceeds a reflectivity threshold, the plurality of distances comprises the present distance, the plurality of reflectivity comprises the present reflectivity, and a plurality of pixels comprising the first pixel are regularly mapping to a two-directional field of view (FOV) of the LiDAR apparatus.

2. The LiDAR apparatus of claim 1, further comprising:
a beam steering unit, optically coupled to the light transmitter and the light receiver, wherein the beam steering unit is configured to steer the pulse light and the reflected pulse light such that the light transmitter scans in the two-directional FOV;
wherein the pulse light incident on the beam steering unit and the reflected pulse light deflected by the beam steering unit are parallel or coaxial, or wherein the pulse light deflected by the beam steering unit and the reflected pulse light incident on the beam steering unit are parallel or coaxial;
wherein the light transmitter comprises at least one source configured to emit the pulse light;
wherein the light receiver comprises at least one light detector configured to capture the reflected pulse light;
wherein the event detector determines whether a plurality of distance differences comprising the distance difference exceed the distance threshold or whether a plurality of reflectivity differences comprising the reflectivity difference exceed the reflectivity threshold substantially pixel by pixel.

3. The LiDAR apparatus of claim 1,
wherein the light transmitter comprises a plurality of light sources configured to emit the pulse light to flash all the two-directional FOV at a time;
wherein the light receiver comprises a plurality of light detectors configured to receive the reflected pulse light from the two-directional FOV at a time;
wherein the event detector determines whether a plurality of distance differences comprising the distance difference exceed the distance threshold or whether a plurality of reflectivity differences comprising the reflectivity difference exceed the reflectivity threshold for all the plurality of pixels substantially at a time.

4. The LiDAR apparatus of claim 1, further comprising:
a beam steering unit, optically coupled to the light transmitter or the light receiver, wherein the beam steering unit is configured to steer the pulse light or the reflected pulse light such that the light transmitter scans in part of the two-directional FOV;
wherein the light transmitter comprises a plurality of light sources configured to emit the pulse light to flash part of the two-directional FOV at a time;
wherein the light receiver comprises a plurality of light detectors configured to capture the reflected pulse light from part of the two-directional FOV at a time;
wherein the event detector determines whether a plurality of distance differences comprising the distance difference exceed the distance threshold or whether a plurality of reflectivity differences comprising the reflectivity difference exceed the reflectivity threshold substantially group by group.

5. The LiDAR apparatus of claim 1, wherein the event detector does not output a present distance of a second pixel of the present frame or a present reflectivity of the second pixel of the present frame after determining a distance difference between the present distance of the second pixel of the present frame and a previous distance of the second pixel of a previous frame does not exceed the distance threshold and determining a reflectivity difference between the present reflectivity of the second pixel of the present frame and a previous reflectivity of the second pixel of the previous frame does not exceed the reflectivity threshold, and the plurality of pixels comprises the second pixel.

6. The LiDAR apparatus of claim 1, further comprising:
a storage circuit, coupled between the event detector and the determination circuit, the storage circuit comprises a plurality of memory units, and the plurality of memory units are configured to store the plurality of distances and the plurality of reflectivity over all the two-directional FOV respectively.

7. The LiDAR apparatus of claim 1, wherein the determination circuit comprises:
a converter, configured to measure a distance-related time difference between a receipt timing of the reflected pulse light corresponding to the first pixel and an emission timing of the pulse light corresponding to the first pixel or a reflectivity-related time difference between a falling edge of a photo-voltage and a rising edge of the photo-voltage, wherein the converter is configured to convert the distance-related time difference into the present distance or convert the reflectivity-related time difference into the present reflectivity, and the rising edge of the photo-voltage is associated with the receipt timing of the reflected pulse light corresponding to the first pixel.

8. The LiDAR apparatus of claim 1, wherein the determination circuit comprises at least one extraction circuit, and each of the at least one extraction circuit comprises:
an amplifier, coupled to one of at least one light detector of the light receiver, wherein the amplifier is configured to convert a photo-current into a photo-voltage, and the light detector is configured to convert light intensity of the reflected pulse light corresponding to the first pixel into the photo-current; and
a comparator, coupled to the amplifier, wherein the comparator is configured to determine a falling edge of the photo-voltage or a rising edge of the photo-voltage.

9. The LiDAR apparatus of claim 1, wherein the determination circuit comprises:
a converter, coupled to one of at least one light detector of the light receiver, wherein the converter is configured to transform light intensity of the reflected pulse light corresponding to the first pixel into the present reflectivity.

10. The LiDAR apparatus of claim 1, wherein the determination circuit comprises:
a comparator, coupled to the light transmitter, wherein the comparator is configured to determine an emission timing of the pulse light corresponding to the first pixel.

11. An event detection method, for a light detection and ranging (LiDAR) apparatus, comprising:
obtaining a present distance of a first pixel of a present frame or a present reflectivity of the first pixel of the present frame; and
output the present distance or the present reflectivity only after determining a distance difference between the present distance of the first pixel of the present frame and a previous distance of the first pixel of a previous frame exceeds a distance threshold or only after determining a reflectivity difference between the present reflectivity of the first pixel of the present frame and a previous reflectivity of the first pixel of the previous frame exceeds a reflectivity threshold;
wherein a plurality of pixels comprising the first pixel are regularly mapping to a two-directional field of view (FOV) of the LiDAR apparatus.

12. The event detection method of claim 11, further comprising:
determining whether a plurality of distance differences comprising the distance difference exceed the distance threshold or whether a plurality of reflectivity differences comprising the reflectivity difference exceed the reflectivity threshold substantially pixel by pixel;
wherein a light transmitter of the LiDAR apparatus comprises at least one source configured to emit pulse light, the pulse light is non-visible;
a light receiver of the LiDAR apparatus comprises at least one light detector configured to capture reflected pulse light, the reflected pulse light represents the pulse light reflected by at least one object;
a beam steering unit of the LiDAR apparatus is configured to steer the pulse light and the reflected pulse light such that the light transmitter scans in the two-directional FOV; and
the pulse light incident on the beam steering unit and the reflected pulse light deflected by the beam steering unit are parallel or coaxial, or wherein the pulse light deflected by the beam steering unit and the reflected pulse light incident on the beam steering unit are parallel or coaxial.

13. The event detection method of claim 11, further comprising:
determining whether a plurality of distance differences comprising the distance difference exceed the distance threshold or whether a plurality of reflectivity differences comprising the reflectivity difference exceed the reflectivity threshold for all the plurality of pixels substantially at a time;
wherein a light transmitter of the LiDAR apparatus comprises a plurality of light sources configured to emit the pulse light to flash all the two-directional FOV at a time, the pulse light is non-visible;
a light receiver of the LiDAR apparatus comprises plurality of light detectors configured to receive the reflected pulse light from the two-directional FOV at a time, and the reflected pulse light represents the pulse light reflected by at least one object.

14. The event detection method of claim 11, further comprising:
determining whether a plurality of distance differences comprising the distance difference exceed the distance threshold or whether a plurality of reflectivity differences comprising the reflectivity difference exceed the reflectivity threshold substantially group by group;
a light transmitter of the LiDAR apparatus comprises a plurality of light sources configured to emit the pulse light to flash part of the two-directional FOV at a time, the pulse light is non-visible;
a light receiver of the LiDAR apparatus comprises a plurality of light detectors configured to capture the reflected pulse light from part of the two-directional FOV at a time, the reflected pulse light represents the pulse light reflected by at least one object;
a beam steering unit of the LiDAR apparatus is configured to steer the pulse light or the reflected pulse light such that the light transmitter scans in part of the two-directional FOV.

15. The event detection method of claim 11, further comprising:
obtaining a present distance of a second pixel of the present frame or a present reflectivity of the second pixel of the present frame; and
not outputting the present distance or the present reflectivity after determining a distance difference between the present distance of the second pixel of the present frame and a previous distance of the second pixel of a previous frame does not exceed the distance threshold and determining a reflectivity difference between the present reflectivity of the second pixel of the present frame and a previous reflectivity of the second pixel of the previous frame does not exceed the reflectivity threshold, and the plurality of pixels comprises the second pixel.

16. The event detection method of claim 11, wherein a storage circuit of the LiDAR apparatus comprises a plurality of memory units, the plurality of memory units are configured to store a plurality of distances comprising the present distance and a plurality of reflectivity comprising the present reflectivity over all the two-directional FOV respectively.

17. The event detection method of claim 11, wherein a converter of the LiDAR apparatus is configured to measure a distance-related time difference between a receipt timing of reflected pulse light corresponding to the first pixel and an emission timing of pulse light corresponding to the first pixel or a reflectivity-related time difference between a falling edge of a photo-voltage and a rising edge of the photo-voltage, the converter is configured to convert the distance-related time difference into the present distance or convert the reflectivity-related time difference into the present reflectivity, and the rising edge of the photo-voltage is associated with the receipt timing of the reflected pulse light corresponding to the first pixel.

18. The event detection method of claim 11, wherein one of at least one light detector of a light receiver of the LiDAR apparatus is configured to convert light intensity of reflected pulse light corresponding to the first pixel into a photo-current, one of at least one amplifier of the LiDAR apparatus coupled to the light detector is configured to convert the photo-current into a photo-voltage, and one of at least one comparator of the LiDAR apparatus is configured to determine a falling edge of the photo-voltage or a rising edge of the photo-voltage.

19. The event detection method of claim 11, wherein a converter of the LiDAR apparatus is configured to transform light intensity of reflected pulse light corresponding to the first pixel into the present reflectivity.

20. The event detection method of claim 11, wherein a comparator of the LiDAR apparatus is configured to determine an emission timing of pulse light corresponding to the first pixel.
